(19) United States
(12) Patent Application Publication
(10) Pub. No.: US 2002/0119824 A1
(43) Pub. Date: Aug. 29, 2002

(54) Tournament network for linking amusement games

(76) Inventor: Jeffrey L. Allen, Sammamish, WA (US)

Correspondence Address: Daniel J. Burnham, Esp., Jenkens & Gilchrist, P.C., Suite 2600, 225 West Washington Street, Chicago, IL, 60606-3418, US

(21) Appl. No.: 10/083,002

(22) Filed: Feb. 26, 2002

Related U.S. Application Data
(60) Provisional application No. 60/271,968, filed on Feb. 28, 2001.

(51) Int. Cl. G06F 17/00

(52) U.S. Cl. 463/42

(57) ABSTRACT

Apparatus and methods for coordinating tournaments among multiple amusement games are disclosed. Tournaments of differing geographic and temporal scope are accomplished using communications systems linking amusement games at multiple sites. Player interactivity is enhanced through the communication of player game statistics and other player information between amusement game devices and also through the availability of such information over the Internet. Specialized tournament servers may be used to coordinate tournaments among multiple users, including tournaments involving different genres of games.

### FIELD OF THE INVENTION

The present invention relates generally amusement games and more particularly relates to a network for providing amusement game tournaments.

### BACKGROUND OF TIE INVENTION

Traditionally, amusement game machines such as those found in arcades and other social and entertainment establishments have been limited in scope to providing entertainment for those on site at the single amusement game machine. Competition on such games has taken the form of competition between players on the same game at the same time, or between players on the same game at different times via a high score system in the amusement game machine.

With the increasing ability of communications technology to handle large streams of information, a desire has sprung up between players of amusement game machines to expand the scope of competition in the same way that other forms of communication have been expanded. Further, there is a general desire among players of amusement games to increase the number of participants in a competition to make competitions more contested and exciting. There exists a need for a system that provides for increased numbers of competitors on amusement game machines and allows for a variety of competitions of varying temporal, difficulty, and geographic scope.

### SUMMARY OF THE INVENTION

In accordance with one aspect of the present invention, there is provided a method and apparatus for running tournaments among users of amusement game machines in a variety of game machine sites.

In one embodiment of the present invention, a plurality of amusement game machines is adapted for communication with one or more web servers via the Internet, to form a tournament network. The web servers may be adapted to collect scoring and other information from the amusement game machines and combine the scores and other information to determine tournament outcomes. In an alternative embodiment, a tournament network may be formed using a proprietary network rather than the Internet, or a combination of the Internet and a proprietary network may be used.

In an alternative embodiment, the web servers are adapted to group the amusement game machines into tournament groups. Example bases for tournament groups consist of geographic location, types of games or specific games available for play on the amusement game machines, types of game machine sites, and other characteristics of the amusement game machines or amusement game machine sites.

A variety of methods for awarding players of amusement game machines connected to a tournament network are provided. Players may be awarded with prizes such as food, drink, or other goods and services by local owners of amusement game machines connected to the tournament network, or with credits for merchandise over the tournament network. Proper award levels may be determined by servers connected to the tournament network.

### BRIEF DESCRIPTION OF THE DRAWINGS

The foregoing and other advantages of the invention will become apparent upon reading the following detailed description and upon reference to the drawings in which:

FIG. 1 is a block diagram showing components and connections in a tournament network according to one embodiment of the present invention;

FIG. 2 is a block diagram of a tournament updating routine;

FIG. 3 is a display of a regional tournament grouping scheme according to one embodiment of the present invention;

FIG. 4 is a block diagram showing scoring combinations according to one embodiment of the present invention;

FIG. 5 is a diagram of a game device according to one embodiment of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intent is to cover all modifications, equivalents, and alternatives falling within the spirit and scope of the invention as defined by the appended claims.

### DETAILED DESCRIPTION OF THE INVENTION

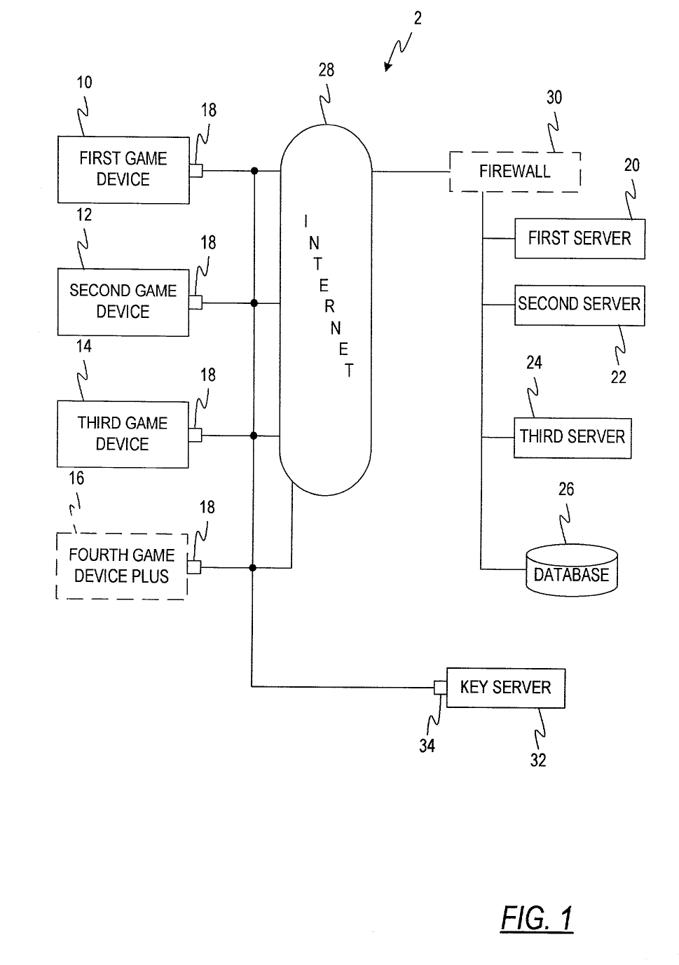

Turning now to the drawings and referring initially to FIG. 1, there is depicted a tournament network 2 with a number of amusement game devices 10, 12, 14, and 16 being adapted for use in amusement game tournaments. The fourth game device (plus) 16 is shown to indicate that a number of additional amusement game devices may be adapted for use with the present invention (indeed the present invention is capable of supporting hundreds of amusement games or more) but for the purposes of clarity only four amusement game devices 10, 12, 14, and 16 have been shown. The systems and methods of the present invention are capable of providing many types of tournaments. For example, tournaments under the present invention may be elimination tournaments in which a certain number of participants are eliminated based on their performance in tournament rounds. A tournament may also be a general contest among competitors with no elimination, with tournament winners being decided upon by performance over several rounds. Further, tournaments may be provided wherein only one round of play is carried out.

The amusement game devices 10, 12, 14, and 16 may be individual game devices, or they may be multiple player game devices allowing multiple players to play in series or simultaneously. Each amusement game device 10, 12, 14, and 16 has a connected communication device 18. In a preferred embodiment, the communication devices 18 are modems capable of transmitting and receiving data at 56 kilobits per second, but it is to be understood that the communication devices 18 may be faster or slower modems, Ethernet or other network cards, wireless communications devices, and other types of devices capable of sending and/or receiving information. Further, the communication devices 18 need not be the same across all game devices 10, 12, 14, and 16, but rather a variety of communication devices may be used with the present invention. For example, some game devices may be equipped with modems while others may be equipped with network cards or some other type of communication device.

The amusement game devices 10, 12, 14, and 16 may be identical amusement game devices, or they may be a variety of different types of amusement devices. For example, a first game device 10 may be adapted for playing a racing game, a second game device 12 may be adapted for playing a golf game, and a third game device 14 may be adapted for playing a variety of different puzzle or arcade-style games. The tournament network 2 is adapted to provide tournaments among two or more different types of games, as well as tournaments involving only one game type. The amusement game devices 10, 12, 14, and 16 may be located at a variety of types of businesses or workplaces or in homes. For example, amusement game devices adapted for use with the present invention may be personal computers, home video game consoles, full-size arcade games, pinball games, or table-top arcade or tavern games as are known in the game field, and the game devices may be located at restaurants, taverns, arcades, shopping malls, department stores, airports, and other public or private locations. The tournament network 2 may be adapted for use with handheld games with wired or wireless communications capability. In one embodiment, gaming machine sites may be provided with gaming machine site servers, which communicate with individual gaming machines and serve as a nexus for communication with network servers 20, 22, and 24.

The tournament network 2 provides a standardized environment for conducting tournaments between individual game devices 10, 12, 14, and 16 on a variety of scales. Under one manner of enabling such functionality in the present invention, the game devices 10, 12, 14, and 16 are equipped to communicate with one or more centralized servers 20, 22, and 24 and further to send information to or retrieve information from one or more databases 26. One method of enabling this communication is to connect the game devices 10, 12, 14, and 16, the servers 20, 22, and 24, and the database 26 via the Internet 28. Other types of communication setups are possible. In one embodiment, the components communicate over UUNET™, a networking service provided by the Worldcom Company. In other embodiments, the components may communicate directly via the Internet (through, for example, an Internet service provider), via a virtual private network (VPN), or via a proprietary wide-area network (WAN).

The servers 20, 22, and 24 may be web servers, and further they may be adapted to include servlets which may initiate and complete the tasks involved in coordinating tournaments on the network.

In order to maintain the integrity of information sent between the components of the tournament network 2, a number of security schemes may be employed. For example, a firewall 30 may be set up between the game devices 10-16 and the server and database components. Further, a key server 32 with a key server communication device 34 could be employed, as is known in the communications field.

The tournament network 2 allows a variety of functions to be performed by the game devices 10-16, the servers 20-24, and the database 26 to create a seamless interactive tournament environment for game players. Several different tournament types will now be described to illustrate the operation of the tournament network 2.

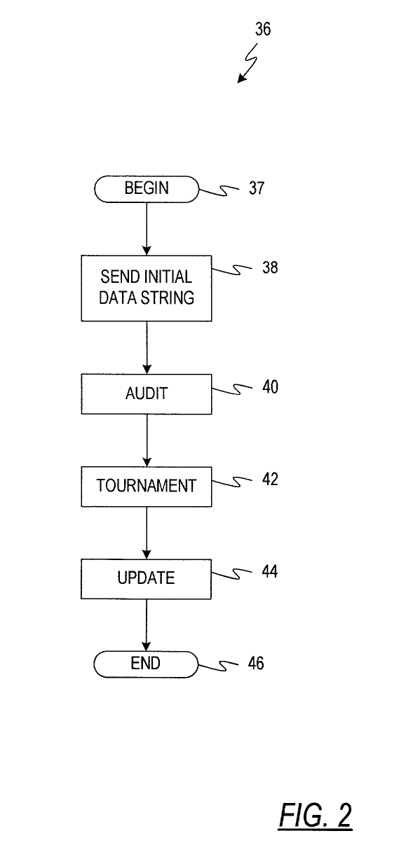

One type of tournament that may be enabled using the present invention is a long term tournament taking place over two days or longer. One factor presented in a long term tournament is that information such as player scores and rankings should be periodically updated so that players can receive updates on their status in the tournament. A long term tournament may be automatically initiated by the servers 20, 22, and 24, or initiated manually by users of the servers, or they may be requested and/or initiated by owners or operators of game devices adapted for use with the tournament network. A long term tournament requires one or more tournament update routines to be carried out by the game devices 10, 12, 14, and 16 and by the servers 20, 22, and 24, and further may require multiple updates to or queries of the database 26. One type of tournament update routine 36 is illustrated in FIG. 2.

Tournament update routines may be carried out via calls automatically being made by an amusement game device 10 through a communication device 18 at predetermined times, or they may be manually initiated by users of the amusement game device 10. Further, alternative tournament update routines may be used wherein one or more of the servers 20, 22, and 24 are adapted to automatically initiate tournament update communications with one or more of the amusement game devices 10, 12, 14, and 16.

FIG. 2 depicts one type of tournament update routine 36. In one embodiment, the tournament update routine 36 is begun at the “begin” block 37 by a communication device 18 connected to an amusement game device 10 contacting a server 20. This may be through a modem call using the TCP/IP protocol. In an alternative embodiment, a tournament update routine may be begun via the server 20 initiating communication with the amusement game device 10. Though one amusement game device and one server will be used for this description, it is to be understood that multiple amusement game devices and/or multiple servers may be performing identical or similar routines at the same time. In addition, although several different communication steps are described in series, it is to be understood that the communication steps may be take place in a different order, or that communication steps may be added or eliminated.

After the initial establishment of a communication pathway, the tournament update routine 36 continues with the sending of an initial data string from the amusement game device 10, as shown at block 38. The initial data string contains information initializing the communication, and may further contain information pertaining to the identity of the sending amusement game device 10 and protocol data units (PDUs) defining the type of information transmission. Further, the initial data string contains information identifying the transmission as a tournament related transmission.

Next, as shown at block 40, an audit communication step is initiated. Audit a messages are used in the tournament network 2 to keep track of several pieces of information dealing with the status of a game device 10. An audit message includes such information as game device and/or communications device statistics, error conditions of the game device and/or communications device, percentage of disk space currently in use on a game device and amount of remaining disk space, play counts, the number of different players, the total number of credits, service credits, and free plays granted on the game device, and other information dealing with the day-to-day operation of a game device. The audit message may optionally contain a log of operations performed by the game device 10.

Next, as shown at block 42, tournament related communications take place between the game device 10 and the server 20. Scores, lap times, and other information regarding players participating in a tournament are sent from the game device 10 to the server 20. These scores may have been stored over a time period stretching from seconds to days by the game device 10 before being sent. In one embodiment, the game device 10 stores player scores and other information until an internal memory is filled and then automatically initiates a tournament update routine 36.

In the tournament communications step 42, the game device 10 may optionally receive tournament definitions from the server 20. Tournament definitions include the information necessary for the game device 10 to offer a tournament choice to a player, including the game or games involved in the tournament, the region of the tournament, the tournament duration, the expected skill level of the tournament, and other tournament-related information.

Further, the game device 10 may optionally receive tournament leader board information from the server 20. The server 20 or game device 10 may query the database 26 using structured query language (SQL) or other querying methods to receive this information, or the information may be stored locally on the server. One or more servers may constantly be adding or retrieving information to and from the data base 26 to create information compilations such as a tournament leader board.

In addition, during the tournament communication, the game device 10 may receive tournament prize information and/or values from the server 20. The tournament prize types and values can vary based on the number of tournament participants, the types of games involved in the tournament, the difficulty of the tournament or skill of players in the tournament, and other factors related to the tournament.

Next, as shown in block 44, an update communication between the amusement game device 10 and the server 20. During the update communication, new features such as tracks for racing games, courses for golf games, and puzzle and trivia data for puzzle and trivia games are sent to the amusement game device 10. The update function of a tournament network 2 according to the present invention is described in greater detail below.

Finally, once the amusement game device 10 and/or the server 20 have determined that all necessary data has been transferred during the tournament update routine 36, the communication is terminated as shown by the “end” block 46.

A long term tournament may be initiated by operators of a server 20. The operator inputs information defining the tournament. Some tournaments involve numerous different games. If an operator desires numerous games to be involved in the tournament, the tournament defining information will include the types of games involved. The operator may choose from a list of available games and determine, for example, that the tournament will involve two plays of a driving game, four plays of a golf game, and one play of a particular puzzle game on a game machine capable of playing numerous games. Specific arcade games such as driving games and golf games may be provided on amusement game devices 10 customized for that particular style of game, or multipurpose amusement game devices, having a variety of arcade, puzzle, and trivia games may be used. In defining a tournament, the operator will also enter the duration of the tournament. For example, in a tournament involving seven different plays of various games, a duration of three days might be selected. This would require players entering the tournament to play the required amount of games within three days. If a player falls short of the required number, the player's score may be decreased accordingly, or the player may be disqualified from the tournament.

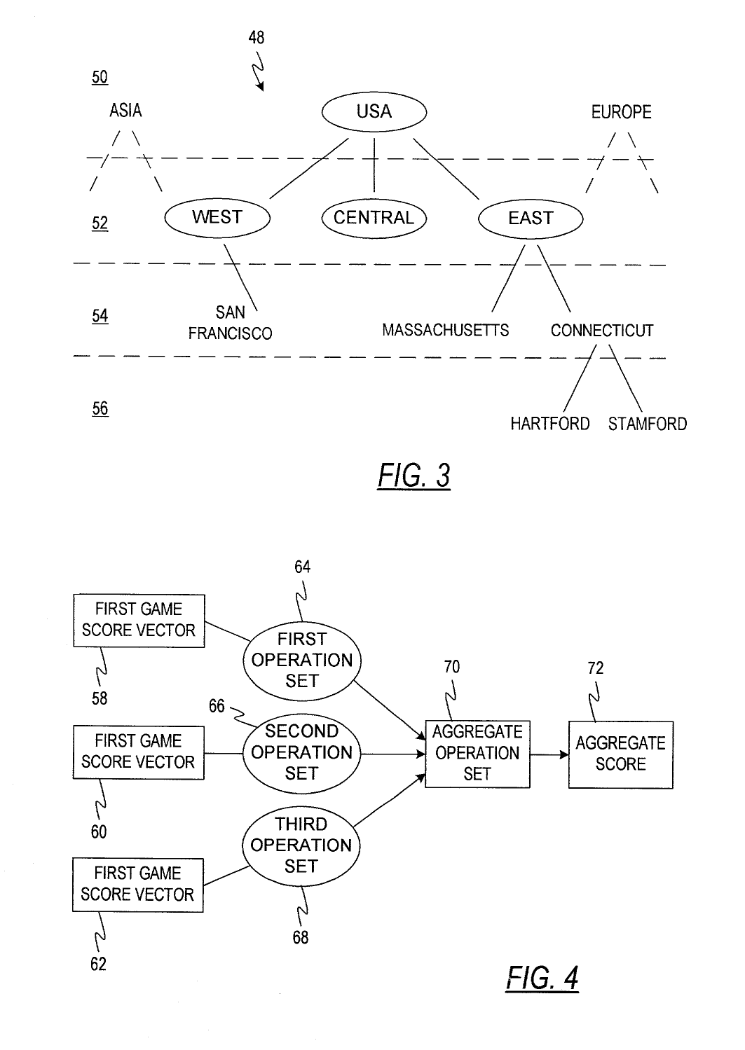

The operator also enters grouping information for the tournament. Grouping information allows the operator to define a variety of player and/or game machine characteristics that will be involved in the tournament. One type of grouping criterion is location-based grouping. A nationwide tournament may be subdivided into defined locations to increase the competitive nature of a tournament within a region or between regions. FIG. 3 shows an example of region-based grouping enabled by the present invention. The regions are organized in a tree structure 48, with a first regional level 50 containing regions on the nation or continent scale. Example regions contained in this level include the United States of America, Asia, and Europe. A second regional level 52 is used to subdivide the regions in the first regional level 50 for the purposes of more easily defining a subset of amusement game devices to participate in the tournament. For example, the second regional level 52 beneath the first regional grouping corresponding to the U.S. may include groups for the Western, Central, and Eastern United States. Regional levels are not necessarily rigid, and may fluctuate based on population changes or specialized tournaments. An operator may design special regions for particular tournaments. A third regional level 54 further narrows the locations of game devices for use in a tournament. In the illustrated tree structure 48, the third regional level 54 contains regions including both cities, such as San Francisco, and states, such as Massachusetts and Connecticut. A fourth regional level 56 includes subsets of regional levels in the third regional level 54, such as individual game locations or smaller cities within a state, such as Hartford or Stamford, Conn.

The tree structure 48 allows an operator to set up tournaments on a variety of scales. For example, an operator may decide to choose groups from more than one regional level to compete in a tournament. Players from San Francisco may be pitted against players from all of the Central U.S., or against players in Massachusetts and Connecticut. If particular rivalries among regions develop, subsets of these regions may be created by an operator in order to spark more competition. The smallest group possible is a single amusement game, and the largest group consists of every amusement game connected to the tournament network 2, which is essentially unbounded.

Regional grouping allows competition to be segregated among several different groups chosen by a server or operator, and further allows tournaments to be escalated from one group to another group. For example, if a particularly good player is found in San Francisco, the system may automatically recognize that player and allow him into a tournament against players from any other region, to determine the best player in the entire network 2.

The regional grouping also allows different honors to be bestowed upon winners of certain regions, and further allows top players in certain regions to be identified and allowed to play in statewide or nationwide tournaments to determine the best tournament players. For example, the best scoring player from the combined pool of Massachusetts and Connecticut players may be named the East Coast Champion, and could face off against a Central U.S. Champion and a West Coast Champion to determine the National Champion.

In one embodiment of the present invention, tournament scoring is formatted using vectors to organize several aspects of a player's performance. A score vector for use in the present invention is subdivided into two or more portions pertaining to specific aspects of a player's gameplay. For example, in one game used with the tournament network 2, the driving game San Francisco Rush™, a player's performance may be judged by her total race or trial time over multiple plays, the number of special gold coins she collected during play, and the race or trial time of her last play. A template for this score vector would read:

<total time; # of gold coins; last play time>.

With numbers substituted in, the player's score vector could read:

<4:56:73; 6; 39:24:21>

With race or trial times being shown in minutes, seconds, and hundredths of a second.

In an aggregate tournament involving several different game types, a variety of mathematical operations may be performed on score vectors applying to different games to form an aggregate score, as shown in FIG. 4. While the forming of an aggregate score will now be described with respect to three different game types, it is to be understood that score vectors from two or more game types may be combined under the present invention. First, a first game score vector 58 from a first game type, a second game score vector 60 from a second game type, and a third game score vector 62 from a third game type may respectively be subjected to first 64, second 66, and third 68 operation sets. For example, the first 64, second 66, and third 68 operation sets may involve normalizing the scores among the three different game types so as to make the scores more comparable. In a golf game or a racing game, for example, fewer strokes or a shorter race time correspond to a more successful play. In a puzzle game, on the other hand, a higher number of levels passed may correspond to a more successful play. Operations such as multiplying or dividing by a pre-set number or adding or subtracting scores to or from predetermined numbers may be used to make scores on different types of games comparable.

The scores from the individual operation sets 64, 66, and 68 may be further altered in the aggregate using an aggregate operation set 70. The aggregate operation set may comprise adding analogous vector components together to form an aggregate vector, and then mathematically combining the components of the aggregate vector to determine a final aggregate score 72. The final aggregate score 72 is used to rank tournament players for the purpose of determining tournament winners. The final aggregate score 72 from a tournament may also be stored in the database 26 for such purposes as tracking player performance over time or determining the locations of particularly good tournament players.

An operator or server setting up a tournament is provided with several options for scoring types, weights to be given to different games, possible vector components for different games, and operations to be used in developing aggregate scores. Further, an operator may choose to forego the use of an aggregate score and determine tournament winners directly from the highest ranking scorers on each game.

A player may participate in a long term tournament by playing an amusement game device 10. In order to identify the player for the purposes of computing and comparing scores, creating player profiles which include a player's tournament history, and awarding prizes, it will be necessary for a player to identify himself to the game device 10 so that his scores and other information can be forwarded to a tournament server 20. Several different types of identification are available. For example, this identification can take the form of an identification card, such as a magnetic card or a smart card, or it may take the form of a username and password that is input into the game device 10 before the player plays a game. In addition, a player may identify himself and pay for tournament fees or the costs of individual games by using a credit card, debit card, financial smart card, or other identification device, or through biometric identification. These devices may be used in combination with a personal identification number (“PIN”) issued by the card issuer, or in combination with a tournament number issued by a tournament operator. Further, special tournament cards may be issued by tournament operators to identify players and/or to identify tournaments in which players are playing.

After identifying himself to a game device 10, a player may be presented with a tournament selection screen giving the player a choice of possible tournaments to begin or to continue participating in. This list may be formed during the tournament update routine 36, and may be modified in response to player recognition by the game device 10. The game device 10 may receive a list of all possible tournaments that users of the game device 10 may participate in, and further may narrow this list down for a player so as to display only long term tournaments that the player is already competing in. In one embodiment, after selecting a tournament, the player plays a tournament game, and the player's game score and other statistics are stored at the game device 10 until the next tournament update routine 36 is initiated.

Several different long term tournament types are enabled by the present invention in order to appeal to as many potential players as possible. Some players prefer only one type of game—for example, sports games, driving games, or fighting games—while other players prefer a wide variety of games. The tournament network 2 enables these players to enter tournaments that appeal to their own tastes in games. One type of long term tournament may involve several months of playing a driving game. This tournament would appeal to those who only enjoy driving games and keep the game continually interesting by fostering competition among players who enjoy the same type of game. In addition, such a tournament would supply an incentive to keep practicing to improve at the game and thereby improve a player's tournament outcomes. More casual players of different types of games might be more interested in a shorter tournament including several different game types to be played over a period of only a few days or a few weeks, and the scalability of the present invention allows tournaments to be tailored to any type of game player.

Another type of tournament enabled by the tournament network 2 is a shorter tournament of only one day or one evening, or a tournament involving only one play of one game or of several different games. These single game and short term tournaments are executed similarly to long term tournaments, but they will necessitate fewer tournament update routines 36. Single game and short term tournaments would appeal to players who do not frequently visit amusement game devices 10 on location or who do not own personal computers or home game consoles. In a short term or single game tournament, a player may log in with a new user name and password for the evening of the tournament. This information may be stored locally on a game device 10 or may be stored at the database 26. The player then plays the tournament game or games, and at the conclusion of the tournament may once again use the game device 10 to find the outcome of the tournament. Short term and single game tournaments may use the same features and offer many of the same benefits of long term tournaments.

Another type of tournament enabled by the tournament network 2 is a real-time tournament. In a real-time tournament, the communications devices 18 may be constantly connected to one or more servers 20, 22, and 24 to continuously give updates on players' performance and to receive updates on the performance of other players. Further, other game-related information may be sent over the connection, including such information as player position and controller inputs in games such as driving or fighting games where vehicles or characters interact immediately. During a real-time tournament, the amusement game devices 10, 12, 14, and 16 may be adapted to send signals amongst each other to inform other game devices of current or potential competitors and new player arrivals. The game devices may further communicate with respect to player performance, so that individual players will be aware of their status in comparison to other players. Further, the number of players involved in a tournament may be used by a server 20 to determine a prize level for the tournament, with more popular tournaments corresponding to more prizes or higher prize values. Prize level computations may be made automatically by the server 20, according to criteria input by server users.

One type of real-time tournament is a trivia tournament, in which trivia questions are stored at the database 26 and sent to game devices during tournaments. Game devices 10, 12, 14, and 16 adapted to play a trivia game communicate with one or more servers 20, 22, and 24 to send player responses to trivia questions. In one embodiment, both questions and correct answers are sent to the game devices, and the game devices only communicate which questions were answered correctly by the player to the servers.

Another important function served by the game devices and communications devices is synchronization of a competition in a real-time tournament. This is necessary to assure that no player lags behind or gets ahead of any other players, thereby giving the player an unfair advantage or disadvantage or otherwise affecting the tournament. In one embodiment of a real-time tournament, a server 20 is used to initiate a tournament, thereafter dropping out of communication with the game devices and allowing the game devices to communicate tournament data between themselves. All tournament types may be facilitated by the use of a standard application program interface (API) which may be implemented in a wide variety of games for communicating with one or more tournament servers 20, 22, and 24. Further, multicast technology may be used to allow a server 20 to send information instantaneously to multiple game devices, and this technology may be employed over standard networks.

A real-time tournament may be combined with a long term tournament to create an ongoing tournament of real-time tournament events. In such a tournament, players compete against other players during real-time tournaments, and the results of the real-time tournaments are compiled over time, with overall tournament decisions being based on performance over the entire long term tournament.

A wide array of other features may be used in combination with the tournament network 2 to make the tournament network 2 easier to use for game machine owners and operators, network operators, and players. One feature of the present invention is a player website accessible by players over the Internet however they choose to access the Internet. A player website may contain information on the player in a player profile page, which compiles data on games played, tournaments entered, standings in tournaments, prize winnings, and other information. A player may choose to access her player profile page via a game device 10 equipped with a web browser or via any other method of Internet access. Once on the player profile site, a player may choose to add more information to her player profile, personalizing the profile. This ability heightens the sense of competition for players, who may get to know certain particularly good competitors due to their player profile sites created in combination with data from game devices. In addition, a player may add a photograph to her player profile, and this photograph may be superimposed on a character while the player is participating in the tournament. Cameras may also be incorporated into amusement game devices 10 to provide this ability.

Another way of increasing interactivity under the present invention is the use of a tournament web page through which players may set up their own tournaments for a specialized group of participants or using a particularly appealing mix of games. Interactivity may also be increased by having regularly scheduled daily, weekly, or monthly games or tournament events so that players know exactly when and where to play on a regular basis.

Interactivity may further be increased according to the present invention by providing a website where a tournament player can redeem tournament points for prizes. The website may be hosted at one of the servers 20, 22 and 24, or it may be provided by a specialized tournament website servers. Tournament points may be awarded based upon a player's performance in a tournament, and even if a player is not among the top performers in a tournament, tournament points may be awarded to maximize a player's enjoyment of a gaming tournament. Further, in one embodiment players in a tournament are immediately shown what they have won on a display 76 of a game device 10 based on their latest performance and then later collect their winnings. In one embodiment, players are identified by their full legal name and their phone number, and players are called after a tournament to verify their winnings and to confirm delivery options.

Awards from tournaments according to the present invention may be monetary awards or awards of goods or services. Awards may be segregated into separate award value classes for selection and distribution by a server 20. Further, a gaming device 10 according to the present invention may be provided with a keyboard and/or a computer-style mouse for making identification inputs and award selections and also for controlling game action. Embodiments of gaming devices 10 having keyboards and/or mouse peripherals are of particular applicability to an embodiment of the present invention whereby a game device allows users to access the Internet to review tournament information or other information available via the Internet. In one embodiment, a game device 10 may be provided with a list of accessible Internet sites and a player may be allowed to access only those sites from a game device 10.

Player awards may be automatically determined by a server 20 or determined manually based on tournament performance and other factors. In one embodiment, the server 20 automatically selects tournament awards from a list of available tournament awards and organizes the tournament awards into separate value levels. In this embodiment, the server may automatically determine which award value levels should be made available to certain tournament players based upon the tournament players tournament outcomes. Tournament outcomes for use in this embodiment may include players rankings following a tournament, numerical ratings generated after a number of game plays or tournaments, or special achievements in individual games (such as defeating bonus levels or finding hidden objects in games). Further, award levels to be awarded to different players may be adjusted based upon the overall level of achievement in tournament games. For example, a winner in a tournament in which particularly good competitors competed may be awarded more valuable awards than a winner in a tournament in which only mediocre competitors competed.

In one embodiment a first server 20 operates to coordinate tournaments and a second server 22 operates to store and administer player websites. A third server 24 may be adapted to handle accounting functions for the tournament network 2, including keeping track of player accounts maintained so that players do not need to insert money for every play of a tournament game. In the alternative, all of these functions may be carried out by servlets running on a single server 20. The accounting functions also include tracking and updating game device operator accounts and include information on tournament participation. Operator and/or player accounts may be updated in response to the receipt of game audit information as shown at block 40 of FIG. 2. A server performing an accounting function may use electronic funds transfer (EFT) to carry out financial transactions to update accounts.

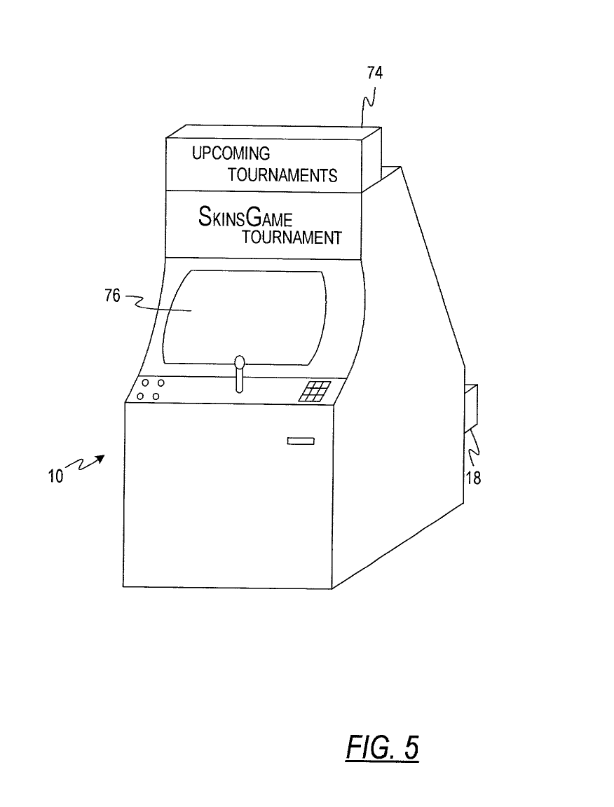

One method of advertising current and upcoming tournaments involves light-emitting diode (LED) signs on amusement game devices. FIG. 5 shows an LED sign 74 connected to a game device 10 according to the present invention. An LED sign 74 is capable of showing many types of information to players and prospective players, and generally is more noticeable from across a room than a standard attract mode of a game device 10. The tournament network 2 is adapted to update information displayed on an LED sign 74, such as currently available tournaments, future tournaments and their dates, tournament leader boards, and past winners and prizes of tournaments. An LED sign 74 may be connected through a game device 10 to a communication device 18 for the purpose of receiving updated messages, or the LED sign 74 may use its own attached communications devices to receive updates. Other types of alterable signs, such as liquid crystal display signs or cathode ray tube-based signs may be updated according to the present invention. Further, specialized leader board signs may be implemented to enable players to track their performance over the course of a tournament.

In addition to or instead of the use of an LED or other type of sign 74 to portray internal network and/or third party advertising messages, tournament updates, and the like, a game screen 76 can accomplish the same tasks. Similarly to the LED sign 74, messages for display on the game screen can be downloaded to the game device 10 via the communication device 18. Tournament news and leader board updates may be provided via the game screen 76 while the game device 10 is not being played.

Other methods and features may be used to increase the appeal of a game device 10 on the tournament network 2. One such method is the provision of bonus games by the amusement game devices. In one embodiment using bonus games, bonus questions, brief bonus rounds, or skill challenges are presented to players. One result of these features is the increase in appeal to players who may not be in the running to win a tournament, but who still want to get some sort of prize or other satisfaction out of the game. For example, a timed flashing button could be provided on the control panel of a game device 10 to carry out a brief reaction challenge bonus game. This button may be energized to flash for a few seconds at various points during a game or tournament. In this example, if a player hits the button while it is flashing, the player may be rewarded with a prize such as food, drinks, game credits, bonus rounds with different entertaining games, and other prizes. In one embodiment, the score from a bonus round may be applied to a tournament. The bonus round score may be used as an additional factor in determining a tournament winner or it may be used as a separate tie-breaking factor in a tournament. Using this embodiment, a player may always be capable of getting some positive outcome from playing a game device 10, even though the player may not have a strong chance of winning a tournament. This embodiment also provides an element of “instant gratification” to supplement a longer tournament experience, and may be used as a sales or marketing technique to increase interest in tournament games among players who are not participating in a tournament.

Similarly, in a trivia challenge, a player is presented with a trivia question. A correct answer to the trivia question results in a success in the trivia challenge. Likewise, a brief arcade challenge can be provided, such that success in a short arcade or puzzle game results in a bonus game win for the player.

In another embodiment, a frequent player reward may be offered to players who use the tournament network 2 for a certain amount of time or for a certain number of games. For example, a player who plays game devices 10 connected to the tournament network 2 fifty times may be rewarded with a frequent player reward of goods or services, such as game merchandise or free plays on tournament games. Someone who has spent a certain amount of time, such as fifty hours, playing tournament network games may be rewarded similarly. These rewards, along with other rewards and prizes given in connection with the tournament network 2, may be provided in the form of prize credits which may be redeemed at a tournament network website over the Internet.

Bonus games may also be awarded in combination with the frequent player reward embodiment. In this combination, bonus games such as trivia questions or brief arcade game sequences may be rewarded intermittently to players of game devices 10 on the tournament network 2. These bonus questions or arcade game sequences may be very difficult for players who have not played games on the tournament network 2 very often, and may be made less difficult for those players who have played more games on the tournament network 2. Awards may be given to players who successfully answer bonus questions or successfully complete arcade game sequences. Because players who have played more games will be given easier questions or arcade game sequences, this system awards players who play more frequently or who play more games overall.

In one embodiment, a collective award system is used to increase the appeal of game devices 10 connected to the tournament network 2. In this embodiment, several game devices 10, which are connected to the tournament network 2, are pooled by a server 20 into a collective award pool. The server 20 collects information such as the number of plays, play time, player success, and money input from the game devices 10. In another embodiment, the functions of the server in pooling game devices 10 and analyzing statistics from the game devices 10 are performed by a separate collective award processor connected to the game devices 10 at the game device site. Data from the pooled game devices 10 may be stored in or accessed from a database 26. In the collective award embodiment, the grouped game devices 10 are monitored by the server 20 or collective award processor for a variety of statistics. If these statistics reach predetermined levels, the player or players of a game device or devices 10 are awarded with a prize such as a free game, food, drinks, or other goods or services.

For example, five game devices 10 at a particular site may be pooled for the purposes of a collective award system by a server 20. These game devices 10 may be monitored for a collective award system based upon total number of plays. Every hundredth play of any of five pooled game devices 10 may result in a collective award being given to the lucky player. In another embodiment, the total money input into the pooled game devices may add to a collective award jackpot, which is awarded to players based on their performance in a game played on a gaming device 10 or their performance in a tournament.

The attachment of a game device 10 through the communication device 18 to the other components of the tournament network 2 allows use of a server 20 in combination with a database 26 to update various aspects of a game device 10. Updates to a game device may include new games or game versions, artwork, trivia questions, courses or roads for existing games, players, characters, vehicles and other game improvements to be communicated to the game device. For example, the game device 10 shown in FIG. 5 is a golf game. The communications device 18 allows a server 20 to send new courses or characters to the game device 10 in order to keep the game device 10 interesting for players who may have grown accustomed to every course. This feature further allows the downloading of specialized tournament courses, so that tournament players will not have an advantage of playing certain courses repeatedly and then excelling at previously played courses in a tournament. This function could also be used for driving games, where new racetracks can be downloaded, or puzzle games where new puzzle words or piece types can be downloaded. In addition, a whole game sequel can be downloaded, removing the need to install new hardware or manually update a game device when a game sequel is created. Bug fixes may also be accomplished through the use of the communication device 18 and the tournament network 2.

In one embodiment, particularly long files are automatically broken up into smaller pieces by a server 20 and then downloaded over a period of several days by a game device 10. In this embodiment, the server 20 keeps track of how much of a file has been transferred and accepted, and starts future file transfers at the point where a previous transfer terminated. Using this method, game updates taking up large amounts of memory do not take up bandwidth that game devices need to conduct tournament-related communications.

While the present invention has been described with reference to one or more particular embodiments, those skilled in the art will recognize that many changes may be made thereto without departing from the spirit and scope of the present invention. Each of these alternative embodiments and obvious variations thereof is contemplated as falling within the spirit and scope of the claimed invention, which is set forth in the following claims.

What is claimed is:

1. A system for providing tournaments for players of amusement game machines comprising:
one or more amusement game machines located at each of a plurality of game machine sites, each of the amusement game machines being adapted for electronic communication via the Internet; and
one or more web servers adapted for communication via the Internet and further adapted to locate and communicate with the amusement game machines via the Internet.

2. The system of claim 1 wherein one or more of the one or more web servers are adapted to group the amusement game machines into tournament groups according to one or more criteria and further wherein one or more of the one or more web servers are adapted to provide tournaments within the tournament groups.

3. The system of claim 2 wherein the criteria are selected from a group consisting of location, geographic region, amusement game machine type, game machine site type, game selection available on the amusement game machines, and difficulty levels available on the amusement game machines.

4. The system of claim 2 wherein the tournaments comprise a plurality of amusement games.

5. The system of claim 4 wherein the amusement games are selected from a group consisting of puzzle games, sports games, and driving games.

6. The system of claim 4 wherein winners of the tournaments are determined by aggregate scores from the plurality of amusement games.

7. The system of claim 1 further comprising one or more updateable tournament leader boards disposed at one or more of the game machine sites.

8. A system for providing tournaments for players of amusement game machines comprising:
one or more amusement game machines disposed at a plurality of game machine sites;
one or more amusement game machine site servers disposed at each of the game machine sites, the amusement game machine site servers being adapted to communicate with one or more of the amusement game machines and with an outside network; and
one or more tournament servers adapted to communicate with the game machine site servers and further adapted to provide tournaments for players of the amusement game machines.

9. A method for providing a tournament for players of amusement game machines comprising:
providing a plurality of game machines at game machine sites for play by tournament players, the game machines including communication devices;
sending game and player information from the game machines via the communication devices to one or more tournament servers, the tournament servers being adapted to accept the information; and
performing operations on the game and player information at the tournament servers, the operations including tracking game and player information and updating game and player information.

10. The method of claim 9 further comprising determining a tournament outcome from the game and player information.

11. The method of claim 10 further comprising informing the tournament players of the tournament outcome.

12. The method of claim 11 further comprising providing successful tournament players with a selection of awards based on the tournament outcome.

13. The method of claim 12 further comprising accepting award choices from the successful tournament players.

14. A system for providing tournaments among players of game devices comprising:
one or more game devices adapted for communication over a network;
one or more servers adapted for communication with the game devices over the network, one or more of the servers being adapted to display a tournament web page allowing player selection of awards; and
one or more databases adapted for communication with the servers over the network, the databases storing player information and information pertaining to game tournaments.

15. The system of claim 14 wherein the network is the Internet and wherein one or more of the game devices are provided with keyboards.

16. The system of claim 15 wherein one or more of the game devices are provided with mouse peripherals.

17. The system of claim 14 wherein the servers are further adapted to organize award levels based on player performance in a tournament and to offer specific award levels to players who have achieved predetermined criteria in the tournaments.

18. The system of claim 18 wherein the predetermined criteria comprise player rankings.

19. The system of claim 18 wherein the predetermined criteria comprise player ratings.

20. The system of claim 17 wherein the award levels are adjusted based upon the average level of player achievement in a tournament.

21. The system of claim 14 wherein the game devices are adapted to play a variety of different games.

22. The system of claim 21 wherein the variety of different games comprises games selected from the group consisting of driving games, sports games, fighting games, adventure games, and puzzle games.

23. A network for providing tournaments among players of amusement game devices, the network comprising:
a plurality of amusement game devices located at game device locations, each amusement game device having a communication device attached thereto;
at least one server configured for communication with the communication devices, the server being adapted to group the amusement game devices based on the game device locations and to provide tournaments for players of the amusement game devices; and
at least one database connected to the server, the database adapted to store information regarding players of the amusement game devices and game results from the amusement game devices.

24. The network of claim 23 wherein the at least one server is further adapted to group the amusement game devices into at least one collective award pool.

25. The network of claim 24 wherein the amusement game devices in the at least one collective award pool are adapted to award players of the amusement game devices with prizes based upon the accumulation of at least one statistic among all amusement game devices in the at least one collective award pool.

26. The network of claim 24 wherein the at least one statistic is selected from the group consisting of total plays of the amusement game devices, total time of play on the amusement game devices, and total money input into the amusement game devices.

27. The network of claim 23 wherein the amusement game devices are adapted to provide at least one bonus game in addition to tournament games, the at least one bonus game having at least one bonus game prize associated therewith.

28. The network of claim 27 wherein the at least one bonus game comprises a brief reaction challenge wherein a player must press a flashing button within a predetermined time period to successfully complete the brief reaction challenge.

29. The network of claim 27 wherein the at least one bonus game comprises a trivia challenge wherein the amusement game device presents a player with at least one bonus game trivia question.

30. The network of claim 27 wherein the at least one bonus game comprises a brief arcade challenge wherein the amusement game device presents a player with a short arcade or puzzle game.
